(19) United States
(12) Patent Application Publication
(10) Pub. No.: US 2026/0088672 A1
(43) Pub. Date: Mar. 26, 2026

(54) ROTOR WEIGHT REDUCTION

(71) Applicant: Rivian IP Holdings, LLC, Irvine, CA (US)

(72) Inventors: Larry Thoua XIONG, Lawndale, CA (US); Dang Dinh DANG, Garden Grove, CA (US); Shreyas KAPATRAL, Fullerton, CA (US); Zahid Mohamed SIDDIQ, Torrance, CA (US); Fan WU, Rancho Palos Verdes, CA (US); Khwaja RAHMAN, Troy, MI (US)

(21) Appl. No.: 18/893,720

(22) Filed: Sep. 23, 2024

(51) Int. Cl. H02K 1/32; H02K 1/276; H02K 21/14

(52) U.S. Cl. CPC H02K 1/32; H02K 1/276; H02K 21/14

(57) ABSTRACT

Aspects of the subject disclosure relate to a set of coaligned mass-reduction openings in a laminate stack for a rotor. These coaligned mass-reduction openings reduce the mass and inertia of the rotor, while avoiding negatively affecting other characteristics of the rotor. In particular, the laminate stack may also include other coaligned openings that are fluidly coupled together to form a fluid channel that allows a cooling fluid to flow therethrough. The set of coaligned mass-reduction openings may be blocked to prevent the cooling fluid from flowing into the mass-reduction openings, as such an undesired flow could reduce the cooling efficiency and affect the rotor balance. The rotor may be provided in a motor for an electric vehicle.

### INTRODUCTION

The present disclosure relates generally to the automotive, manufacturing, and industrial equipment fields. More particularly, the present disclosure relates, for example, to rotor weight reduction.

### SUMMARY

Aspects of the present disclosure relate to systems and methods for providing coaligned mass-reduction openings in a laminate stack of a rotor, to reduce the mass and/or inertia of the rotor, while avoiding negatively affecting other characteristics of the rotor. For example, the laminate stack and/or the rotor may also include other coaligned openings that are fluidly coupled together to form a fluid channel. The fluid channel may allow a cooling fluid to flow through the rotor. The cooling fluid may be blocked from flowing into the mass-reduction openings, to prevent reducing the cooling efficiency and/or affecting the rotor balance.

In the context of electric vehicles, providing fluid-blocked mass-reduction openings in a rotor can help improve the efficiency of the motor, reduce energy usage of the vehicle, and ultimately increase the operating range of a vehicle's battery, which can help to mitigate climate change by reducing greenhouse gas emissions.

In accordance with one or more aspects of the disclosure, a laminate stack for a rotor assembly is provided, the laminate stack including a plurality of laminations in a stacked configuration, in which the plurality of laminations include: a first plurality of respective openings that are coaligned to form at least a portion of a fluid channel for a fluid flow through the laminate stack; and a second plurality of respective openings that are coaligned to form at least a portion of a mass-reduction slot through the laminate stack, and that are blocked from receiving the fluid flow. The laminate stack may also include a first additional lamination at a first end of the laminate stack. The first additional lamination may include a first opening aligned with the first plurality of respective openings in the plurality of laminations to allow fluid to flow through the first opening into the fluid channel; and a first blocking portion that extends over the second plurality of respective openings at the first end to block the fluid flow into the mass-reduction slot.

The laminate stack may also include a second additional lamination at a second end of the laminate stack. The second additional lamination may include a second opening aligned with the first opening and first plurality of respective openings in the plurality of laminations to allow fluid to flow through the second opening from the fluid channel; and a second blocking portion that extends over the second plurality of respective openings at the second end to block the fluid flow into the mass-reduction slot. The plurality of laminations may further include a third plurality of respective openings that are coaligned to form an assembly hole through the laminate stack. The first additional lamination may include a third opening aligned with the third plurality of respective openings to allow an assembly structure to pass through the third opening into the third plurality of respective openings.

The laminate stack may also include a magnet disposed within at least one of the first plurality of respective openings. The first plurality of respective openings may have a first shape, and the second plurality of respective openings may have a second shape different from the first shape. The first shape may be configured to accommodate a magnet and a fluid channel, and the second shape may be configured to mitigate at least one of stress or strain on the laminate stack during operation of a motor comprising the laminate stack.

The plurality of laminations may include a plurality of annular laminations that define an axis, and the second shape may include a height along a radial direction away from the axis, and a width that is at least one and a half times the height. The second shape may include a substantially straight radially inner edge and a substantially curved radially outer edge. The plurality of laminations may include a plurality of annular laminations that define an axis, and the first plurality of respective openings may be radially outward of the second plurality of respective openings. A radius extending radially from the axis through one of the second plurality of respective openings to an outer circumference of the laminate stack may not intersect any of the first plurality of respective openings.

In accordance with other aspects of the disclosure, a rotor assembly for a motor may be provided, the rotor assembly including a rotor core formed of multiple layers arranged along a rotor axis. Each of the multiple layers may include a laminate stack that includes a plurality of laminations in a stacked configuration. The plurality of laminations in each laminate stack may include: a first plurality of respective openings that are coaligned to form at least a portion of a fluid channel for a fluid flow through the rotor core; and a second plurality of respective openings that are coaligned to form at least a portion of a mass-reduction slot through the rotor core, and that are blocked from receiving the fluid flow.

The rotor core may also include a first blocking lamination at a first end of the rotor core; a second blocking lamination at a second end of the rotor core; and one or more additional blocking laminations, each additional blocking lamination disposed between two of the multiple layers. Each of the first blocking lamination, the second blocking lamination, and the one or more additional blocking laminations may include: an opening aligned with the first plurality of respective openings in the laminate stack of an adjacent one of the multiple layers to allow fluid to flow through the fluid channel; and a blocking portion that extends over the second plurality of respective openings in the laminate stack of the adjacent one of the multiple layers to block the fluid flow into the mass-reduction slot.

The rotor assembly may also include an end plate coupled to the laminate stack of one of the multiple layers at a first end of the rotor core, the end plate at least partially defining a fluid inlet that is fluidly coupled to the fluid channel. The multiple layers may be arranged along a rotor axis, each of the multiple layers being circumferentially offset with respect to an adjacent other one of the multiple layers such that the fluid channel and the mass-reduction slot each wind about the rotor axis between opposing axial ends of the rotor core.

In accordance with other aspects of the disclosure, a motor may be provided that includes a stator including stator coils configured to generate a rotating magnetic field; and a rotor. The rotor may include a rotor shaft comprising a shaft channel; and a rotor core disposed about the rotor shaft. The rotor core may include a laminate stack that includes a plurality of laminations in a stacked configuration, in which the plurality of laminations in the laminate stack include: a first plurality of respective openings that are coaligned to form at least a portion of a fluid channel for a fluid flow through the rotor core; and a second plurality of respective openings that are coaligned to form at least a portion of a mass-reduction slot through the rotor core and that are blocked from receiving the fluid flow.

The rotor core further may also include a first blocking lamination at a first end of the rotor core, a second blocking lamination at a second end of the rotor core, and one or more additional blocking laminations between the first end and the second end. Each of the first blocking lamination, the second blocking lamination, and the one or more additional blocking laminations may include: an opening aligned with the first plurality of respective openings in the laminate stack to allow the fluid flow through the fluid channel; and a blocking portion that extends over the second plurality of respective openings in the laminate stack to block the fluid flow into the mass-reduction slot. The motor may be disposed in an electric vehicle.

### BRIEF DESCRIPTION OF THE DRAWINGS

Certain features of the subject technology are set forth in the appended claims.

However, for purpose of explanation, several embodiments of the subject technology are set forth in the following figures.

FIG. 1 illustrates a perspective sectional view of an electric motor in accordance with one or more implementations of the subject technology.

FIG. 2 illustrates a perspective sectional view of a rotor assembly for an electric motor in accordance with one or more implementations of the subject technology.

FIG. 3 illustrates a perspective view of a laminate stack for a rotor assembly in accordance with one or more implementations of the subject technology.

FIG. 4 illustrates a front view of a lamination in accordance with one or more implementations of the subject technology.

FIG. 5 illustrates a front view of a blocking lamination in accordance with one or more implementations of the subject technology.

FIG. 6 illustrates a perspective view of the laminate stack of FIG. 3 with the blocking lamination of FIG. 5 in accordance with one or more implementations of the subject technology.

FIG. 7 illustrates a perspective sectional view of the laminate stack of FIG. 6 in accordance with one or more implementations of the subject technology.

FIG. 8 illustrates another perspective sectional view of a rotor assembly for an electric motor in accordance with one or more implementations of the subject technology.

FIG. 9 illustrates a perspective view of a portion of a rotor assembly having an end plate in accordance with one or more implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the present description relate generally to an electric motor that includes a rotor assembly, such as a rotor assembly with permanent magnets. In one or more implementations, it may be desirable to reduce the mass and/or inertia of the rotor assembly. As examples, reducing the mass and/or inertia of the rotor assembly can help to improve acceleration, and/or disconnect engagement, of the motor, and of any components or systems that are driven by the motor.

In one or more implementations, it may also be desirable to be able to cool the rotor assembly during operation of the electronic motor. For example, one issue that can arise in motor cooling architectures is the concentration of motor losses near the outer surface of the rotor assembly. For example, motor losses give rise to heat generation, which can be extracted through stator and rotor cooling. Excessive heating of the magnets of a motor (e.g., in the rotor assembly) can degrade the magnets over time. In one or more implementations, cooling of the magnets of a rotor assembly may be provided, for example, with flow of a fluid that is directed by end plates of the rotor assembly. Rather than indirectly cooling magnets of a rotor assembly through the rotor core, the magnets can be provided within fluid channels that receive a flow of fluid for cooling the magnets via direct contact with the flow of the cooling fluid. By managing the heat conditions of the magnets, the magnets can be protected from demagnetization. In some implementations, such management can allow the selection of magnets that have lower thresholds for resisting thermal conditions.

However, it can be challenging to provide mass and/or inertia reduction in a rotor assembly that includes fluid channels with fluid flowing along and/or through one or more portions of the rotor assembly. For example, any amount of fluid (e.g., cooling fluid, such as oil) that were to flow into and/or become trapped in a mass-reduction feature could contribute to an overall dynamic balance instability, reduce bearing life, and/or cause noise, vibration, and harshness (NVH) issues. Accordingly, aspects of the subject technology provide for rotor mass reduction that prevents fluid from flowing, collecting, and/or trapping inside the mass reduction features in a rotor assembly.

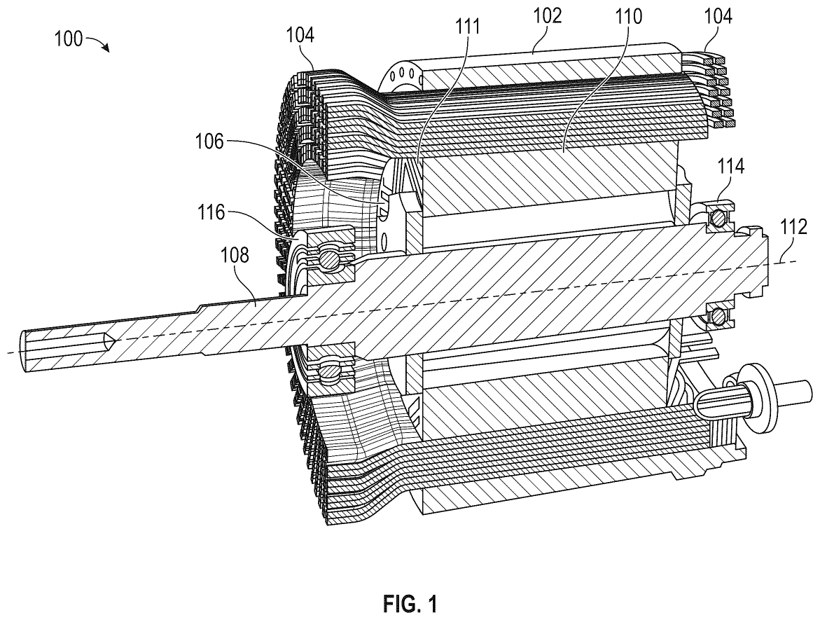

Referring to FIG. 1, a motor can include a stator and a rotor for providing rotational output at a shaft. FIG. 1 is a partial perspective view of a motor 100 having a stator 102 and a rotor assembly 106.

In some embodiments, as shown in FIG. 1, a rotor (e.g., for a motor 100) can include a rotor shaft 108 that is generally cylindrical and that is concentrically surrounded by a rotor assembly 106 that is also generally cylindrical. As used herein, “cylindrical” and “annular” refer to structures having a generally circular internal cross-sectional shape, and likely a roughly circular external cross-sectional shape, although this external cross-sectional shape may vary to some degree, having flat or irregular regions. The rotor shaft 108 and rotor assembly 106 are configured to rotate concentrically about a common central axis 112 in unison, potentially at high revolutions-per-minute (RPM). The rotor assembly 106 can be manufactured from electric steel in one or more implementations. The rotor shaft 108 can be manufactured from steel and/or other possible metal or metal alloy. As shown in FIG. 1, the rotor core 110 can be disposed about the rotor shaft 108.

The motor 100 can include a stator 102 including stator coils 104 configured to generate a magnetic field, such as a rotating magnetic field. The rotating magnetic field can be generated by running multiple-phase currents through the stator coils 104. The stator coils 104 can form segments of its windings distributed about the rotor assembly 106. For example, as shown in FIG. 1, the stator coils 104 can form segments that each extend in a direction that is generally parallel to the central axis 112 of the rotor assembly 106. The rotating magnetic field generated by the stator 102 can rotate about the central axis 112 of the rotor assembly 106. Neither the stator 102 nor the stator coils 104 need to move to generate the rotating magnetic field. For example, the coils can be operated with an alternating current with different segments thereof having a different direction and/or magnitude of current at any given moment. As the current direction and/or magnitude changes for each segment of the stator coils 104 over time, the magnetic field generated in the vicinity thereof can correspondingly change. Accordingly, the resulting magnetic field can be characterized as a magnetic field (e.g., with alternating magnetic field directions extending circumferentially about the central axis 112) that rotates about the central axis 112. The rotating magnetic field can further extend through the rotor assembly 106, which can include permanent magnets 111. The rotating magnetic field generated by the stator 102 can magnetically interact with such components (e.g., the permanent magnets 111) of the rotor assembly 106 to cause the rotor assembly 106 to rotate about the central axis 112.

End windings of the stator coils 104 (e.g., crown end windings and/or weld end windings) of the stator 102 can be of a conductive material such as copper or another suitable metal or material. The end windings of the stator coils 104 may protrude axially beyond the rotor assembly 106 and/or concentrically surround the rotor assembly 106. The end windings of the stator coils 104 may be connected to each other in parallel and/or in series to form a set of winding with multiple-phase terminals, which may be operably connected to a driver, such as an inverter consisting of electrical switches.

The rotor shaft 108 and/or the rotor assembly 106 can be rotated with a first bearing assembly 114 disposed at the first end of the rotor shaft 108 and a second bearing assembly 116 disposed at the second end of the rotor shaft 108. As such, the rotor assembly 106 and/or the rotor shaft 108 can be rotated about the central axis 112 as it responds to the rotating magnetic field generated by the stator 102. The rotor shaft 108 can accordingly provide torque output (e.g., to an external component or system, such as to one or more wheels of an electric vehicle).

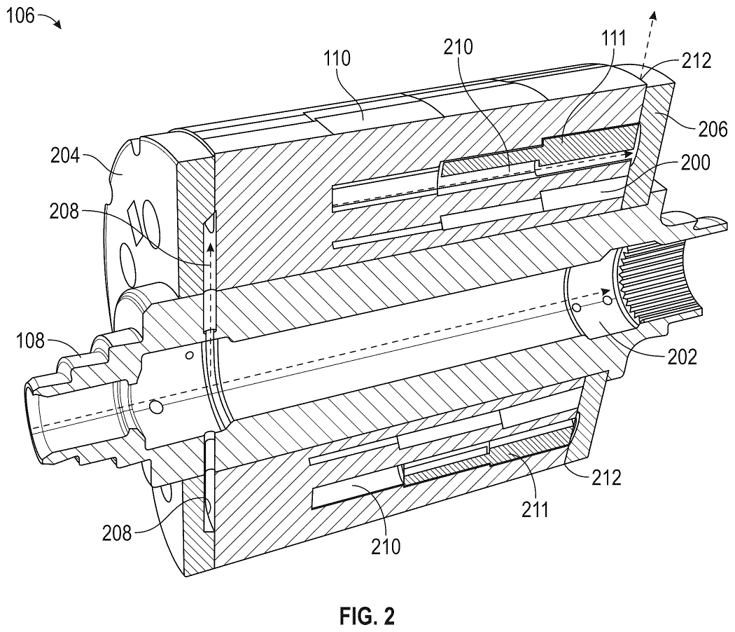

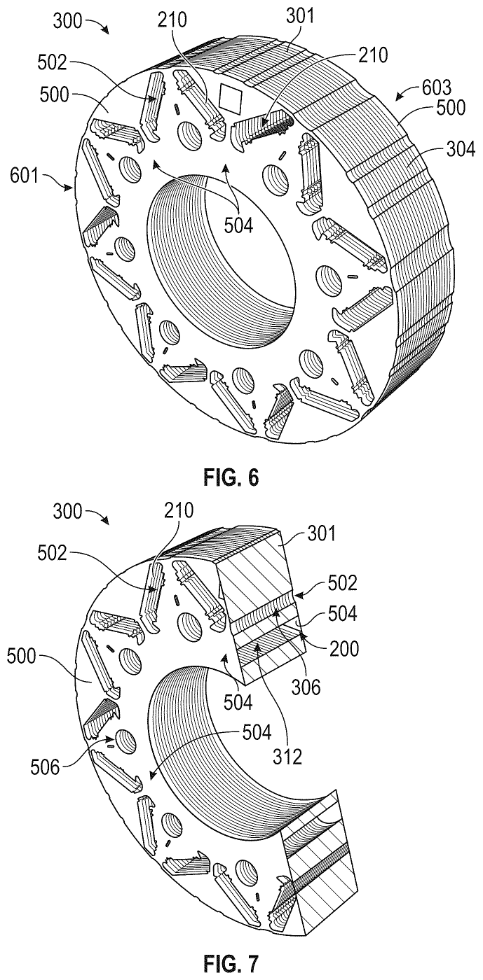

FIG. 2 illustrates a cross-sectional perspective view of the rotor assembly 106, in accordance with one or more implementations. As shown, the rotor assembly 106 may include one or more mass-reduction slots 200. The mass-reduction slots 200 may include openings or cavities within the rotor assembly. As shown, the mass-reduction slots 200 may extend in a direction that is substantially parallel to the axis 112, and partially or completely from one end of the rotor assembly to the other end of the rotor assembly. As discussed in further detail hereinafter (see, e.g., FIGS. 6-8), the mass-reduction slots 200 may be segmented slots having blocking structures that separate multiple segments of the mass-reduction slots 200 from each other. As discussed in further detail hereinafter, this arrangement of mass-reduction slots can help to improve acceleration and/or disconnect engagement of the motor, and of any systems that are driven by the motor, and can also block and/or seal fluid from collecting and trapping inside the mass-reduction slots. Two mass-reduction slots 200 are shown in FIG. 2 (e.g., symmetrically positioned on opposing sides of the central axis 112). However, this is merely illustrative and, as discussed in further detail hereinafter, more than two (e.g., four, six, eight, or more than eight) mass-reduction slots 200 may be provided (e.g., in pairs that are symmetrically positioned on opposing sides of the central axis 112).

In one or more implementations, the rotor assembly 106 may be implemented as an interior permanent magnet (IPM) rotor, which may produce relatively higher torque density and power density due to combined magnet torque and reluctant torque, for example with respect to an induction motor. In one or more implementations, even though IPM rotor losses, core losses, and magnet losses may be relatively lower than traditional induction motors, rotor loss may still occur in permanent magnet motors. For example, rotor losses may translate to heat, which can have an impact on both permanent magnet remanence (Br) and coercivity (Hej), which may result in torque reduction and lower demagnetization protection. Accordingly, rotor cooling can enhance operation of a motor (e.g., an IPM motor) for performance enhancement and achieving an improved demagnetization performance in the motor.

In one or more implementations, in order to achieve cooling of the rotor assembly 106, a fluid (e.g., a liquid lubricant such as oil) may be provided through the rotor assembly 106 via one or more fluid channels 210. For example, the fluid may be provided from a fluid reservoir and directed by a pump to the rotor shaft 108, such as through a shaft channel 202. The fluid reservoir can include and/or be fluidly coupled to one or more other conditioning components, such as a heat exchanger and/or a radiator.

The rotor shaft 108 can define the shaft channel 202, for example along an axis of rotation (e.g., central axis 112 of FIG. 1) of the rotor assembly 106. The rotor core 110 can be disposed about the rotor shaft 108. The rotor core 110 can include one or more layers and define one or more fluid channels 210, each extending between opposing axial ends of the rotor core 110. The rotor assembly 106 can further include one or more first end plates 204 and one or more second end plates 206 at each of opposing axial ends of the rotor core 110.

As shown, the rotor shaft 108 can define one or more first inlet passages 208 passing through a first portion of a wall at a first end of the rotor shaft 108. It will be understood that the first inlet passages 208 can be further defined by one or more channels of the first end plate 204, for example facing the rotor core 110. In one or more implementations, the first inlet passages 208 can be defined by and/or between the first end plate 204 and the rotor core 110. In some implementations, the first inlet passages 208 can be defined entirely within the first end plate 204. The one or more first inlet passages 208 can provide fluid communication between the shaft channel 202 of the rotor shaft 108 and the fluid channels 210 of the rotor core 110. First outlet passages 212 can be defined by one or more channels of the second end plate 206, for example facing the rotor core 110 as described further herein.

In one or more implementations, the rotor shaft 108 can further define one or more second inlet passages passing through a second portion of the wall at a second end of the rotor shaft 108. It will be understood that the second inlet passages can be further defined by one or more channels of the second end plate 206, for example facing the rotor core 110. In one or more implementations, the second inlet passages can be defined by and/or between the second end plate 206 and the rotor core 110. In some embodiments, the second inlet passages can be defined entirely within the second end plate 206. The one or more second inlet passages can provide fluid communication between the shaft channel 202 of the rotor shaft 108 and one or more additional fluid channels of the rotor core 110. Second outlet passages can be defined by one or more channels of the first end plate 204, for example facing the rotor core 110.

During operation of the motor 100, as relatively cool oil enters the shaft channel 202 (e.g., of the hollow rotor shaft 108, as illustrated), the fluid may flow to the first inlet passages 208 (e.g., and the second inlet passages, if present), which are open to the shaft channel 202 proximal to an axial end of the rotor core 110. Each of the first inlet passages 208 (e.g., and the second inlet passages) may include a respective set of channels arranged azimuthally about an axis of rotation (e.g., in an equally spaced pattern or other suitable arrangement). The fluid may flow approximately axially in the fluid channels 210 in a first direction. In one or more implementations, fluid may also flow approximately axially in the one or more additional fluid channels in a second direction opposite the first direction, thus forming an axially cross flow arrangement. As the fluid flows through the fluid channels 210, the fluid absorbs heat generated from losses in the rotor assembly 106 through contact between the fluid, the magnets therein (not shown), and/or the walls of the rotor core 110 (e.g., which may include electrical steel). In implementations in which the fluid channels 210 form a cross flow arrangement, the rotor assembly 106 may exhibit a relatively more uniform temperature gradient (e.g., axial temperature gradients are lessened). The fluid, after absorbing the heat from losses in rotor assembly 106, may flow out of the first outlet passages 212, for example, along the second end plate 206 facing the corresponding side of the rotor core 110. The fluid travels radially outward along the first outlet passages 212 (e.g., due to centrifugal forces). The flow can optionally include cooling and/or other thermal management of the stator (e.g., at the end windings). The fluid may flow, drip, or otherwise return to a reservoir for recirculation in the fluid system (e.g., by operation of a pump to repeat heat transfer in a continuous flow).

In an illustrative example, the motor 100 may correspond to an electric motor having improved performance, due at least in part to a combined reduced mass and effective heat extraction using fewer parts. To illustrate, a rotor such as rotor assembly 106 may exhibit a reduced mass and a uniform thermal gradient while the fluid extracts heat from the core of rotor assembly 106.

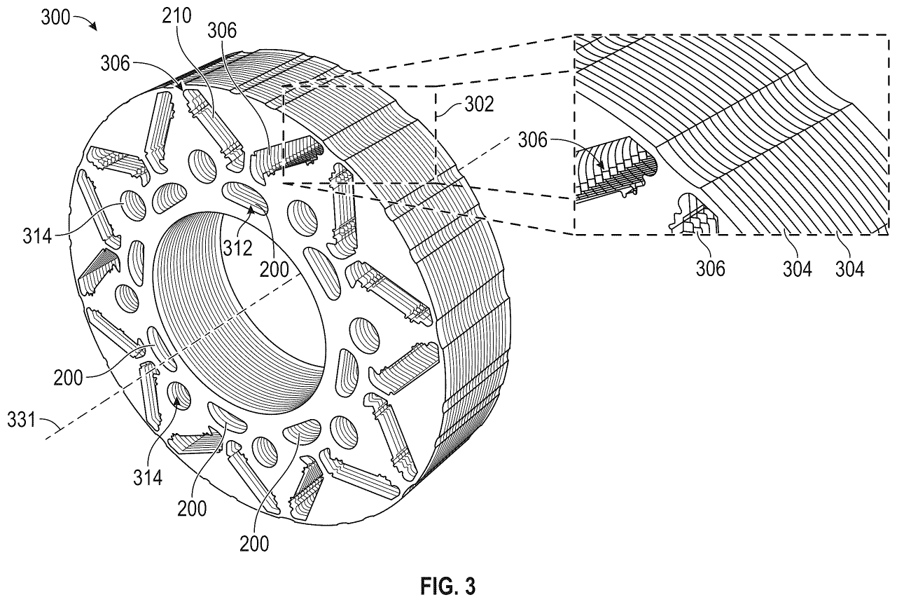

In one or more implementations, the rotor core 110 can be formed from one or more laminate stacks (e.g., each including multiple laminations in a stacked arrangement) and the first and second end plates 204 and 206. For example, FIG. 3 illustrates a perspective view of a laminate stack 300 that may be used to form a part of the rotor core 110 in one or more implementations.

For example, as shown in the expanded view 302 of FIG. 3, a laminate stack 300 (e.g., for a rotor assembly 106) may include multiple laminations 304 in a stacked configuration. As shown in FIG. 3, the multiple laminations 304 may include a first set of respective openings 306 that are coaligned to form at least a portion of a fluid channel 210 for a fluid flow through the laminate stack 300. The multiple laminations 304 may also include a second set of respective openings 312 that are coaligned to form at least a portion of a mass-reduction slot 200 through the laminate stack 300. As discussed in further detail hereinafter, the openings 306 may be fluidly coupled to a fluid inlet and a fluid outlet to receive a fluid flow therethrough, and the openings 312 may be blocked from, and/or sealed against, receiving the fluid flow.

As shown in FIG. 3, in one or more implementations, the multiple laminations 304 may also include a third set of respective openings 314 that are coaligned to form an assembly hole through the laminate stack 300. For example, one or more assembly holes may be configured to receive one or more bolts that pass therethrough to secure the end plates to the rotor core, and/or to receive one or more manufacturing tools (e.g., alignment and/or lifting tools) that hold and/or move the laminate stack and/or rotor core during manufacturing. In one or more implementations, one or more magnets (e.g., permanent magnets 111 of FIG. 1) may be disposed within at least one of the first set of respective openings 306 (e.g., within a fluid channel 210). For example, the openings 306 may be sized, shaped, and positioned, such that a permanent magnet 111 may be partially housed within a first portion of each opening 306, while a second portion of each opening 306 remains unoccupied to allow the cooling fluid to flow therethrough and in contact with the permanent magnet 111.

As shown, the laminations 304 may be annular laminations. For example, each of the laminations 304 may have a central opening defined by a circular inner edge of the lamination 304, and may have a circular outer edge that is concentric with the central opening and the circular inner edge. In this way, the laminations 304 (e.g., the circular inner edges and/or the circular outer edges of the laminations 304) may define an axis 331 of a laminate stack 300. The axis 331 of the laminate stack 300 may correspond to (e.g., coincide with and/or align with) the axis 112 of the rotor assembly 106 when the laminate stack 300 is implemented in the rotor assembly 106.

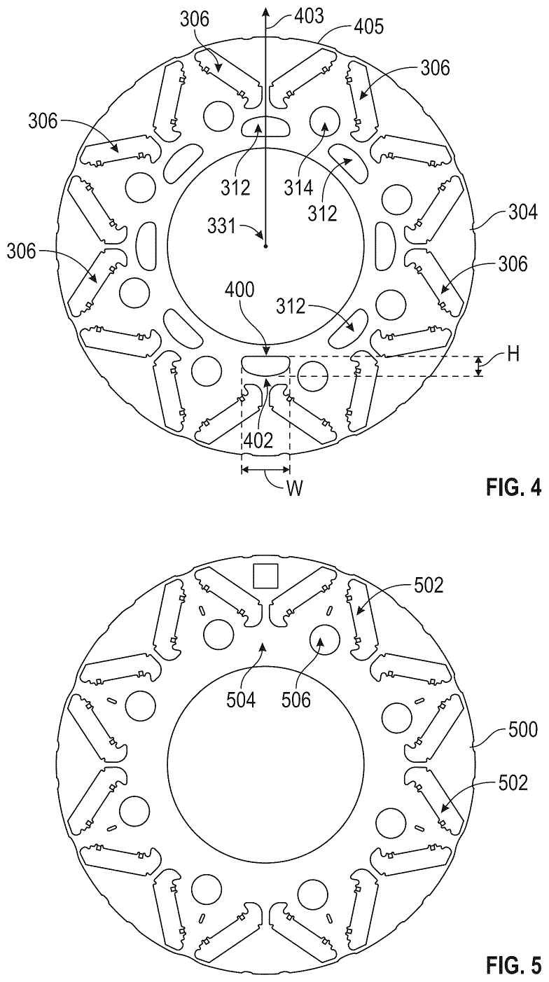

FIG. 4 illustrates a face-on view of one of the laminations 304 of FIG. 3. As can be seen in FIG. 4, each lamination 304 may have multiple of the openings 306, each of which may have a first shape. As shown, each lamination 304 may have multiple of the openings 312, each of which may have a second shape different from the first shape. For example, the first shape of the openings 306 may be configured to accommodate a magnet (e.g., a permanent magnet 111) and a fluid channel (e.g., fluid channel 210) as discussed herein. The second shape of the openings 312 may be configured to mitigate at least one of stress or strain on the laminate stack during operation of a motor that includes the laminate stack.

As shown in FIG. 4, the second shape of the openings 312 may include a height, H, (e.g., along a radial direction extending away from the axis 331), and a width, W (e.g., along a direction perpendicular to the radial direction), that is greater than the height (e.g., at least one and a half times the height, or at least double the height). For example, the width, W, may be greater than ten millimeters, twelve millimeters, or fifteen millimeters, and/or between five millimeters and one hundred millimeters, in one or more implementations. For example, the height, H, may be less than eight millimeters, less than six millimeters, or less than five millimeters, and/or between one millimeter and eighty millimeters, in one or more implementations. As shown, the second shape may include a substantially straight radially inner edge 400 and a substantially curved radially outer edge 402. The inner edge 400 may be closer to the axis 331 than the outer edge 402 is to the axis 331. As shown, the substantially curved outer edge may extend from ends of the substantially straight inner edge.

In the example of FIG. 4, the openings 306 that form the fluid channels 210 may be formed in adjacent sets of first and second openings 306, with each fluid channel in a pair rotated (e.g., forty five degrees azimuthally) relative to the other fluid channel in that pair. As shown, the openings 314 may be substantially circular openings in one or more implementations.

As shown in the example of FIGS. 3 and 4, the openings 306 may be disposed radially outward of (e.g., further from the axis 331 than) the openings 312. As shown in FIG. 4, the openings 306 and the openings 312 may be sized, shaped, arranged, and positioned, such that one or more radii, such as a radius 403, extending radially from the axis 331 through one of the openings 312 (e.g., through a center of one of the openings 312) to an outer circumference 405 (e.g., a circular outer edge) of the lamination 304 (e.g., and the laminate stack 300) does not intersect any of the openings 306.

In one or more implementations, the laminate stack 300 of FIG. 3 may be provided with one or more additional laminations, such as one or more end laminations or blocking laminations (e.g., sealing laminations in some implementations) at one or both ends of the laminate stack. For example, FIG. 5 illustrates an example of a blocking lamination 500. As shown, the blocking lamination 500 may include one or more openings 502 that are configured (e.g., sized, shaped, positioned, and/or arranged) to be aligned with the openings 306 in the laminations 304, to allow fluid to flow through the openings 502 into the fluid channels 210 formed by the openings 306. For example, the openings 502 may have substantially the same shape, size, and/or position as corresponding openings 306 in the laminations 304. As shown, the blocking lamination 500 may also include one or more blocking portions 504 that are configured (e.g., sized, shaped, positioned, and/or arranged) to extend over the openings 312 of a lamination 304, to block fluid flow into openings 312 and the mass-reduction slots 200 formed thereby. As shown, the blocking lamination 500 may include one or more openings 506 that are configured (e.g., sized, shaped, positioned, and/or arranged) to be aligned with the openings 314 in the laminations 304.

In one or more implementations, a laminate stack 300 may be provided with one or more of the blocking laminations 500 at a first end thereof, and/or one or more of the blocking laminations 500 at a second end thereof. For example, FIG. 6 illustrates an example implementation in which the laminate stack 300 of FIG. 3 is provided with a blocking lamination 500 at a first end 601 (e.g., a first axial end) of the laminate stack 300, and a blocking lamination 500 at a second end 603 (e.g., a second axial end) of the laminate stack 300. In one or more other examples, the laminate stack 300 may include two (or more than two) blocking laminations 500 (e.g., with openings and blocking portions thereof coaligned) at the first end 601 (e.g., a first axial end) of the laminate stack 300, and two (or more than two) blocking laminations 500 at the second end 603 (e.g., a second axial end) of the laminate stack 300. For example, a first side of a first blocking lamination 500 may be laminated to the outermost lamination 304 at the first end 601 of the laminate stack 300, and a second blocking lamination 500 may be laminated to an opposing second side of the first blocking lamination 500 that is laminated to the outermost lamination 304 at the first end (e.g., with openings and blocking portions aligned with those of the first blocking lamination). In this example, a first side of a third blocking lamination 500 may be laminated to the outermost lamination 304 at the second end 603 of the laminate stack 300, and a fourth blocking lamination 500 may be laminated to an opposing second side of the third blocking lamination 500 (e.g., with openings and blocking portions aligned with those of the third blocking lamination) that is laminated to the outermost lamination 304 at the second end. In the perspective view of FIG. 6, it can be seen that the openings 502 align with the fluid channels 210 formed by the openings 306, and that the blocking portions 504 extend over the openings 312 to block (e.g., or seal) the mass-reduction slots 200 at the respective ends of the laminate stack 300.

FIG. 7 illustrates a cross-sectional perspective view of the laminate stack of FIG. 6. In the example of FIG. 7, it can be seen that the blocking lamination 500 at the second end 603 of the laminate stack 300 includes an opening 502 aligned with the openings 306 that form the fluid channel 210 (e.g., to allow to flow through the opening 502) from the fluid channel, and a blocking portion 504 that extends over the openings 312 at the second end to block the fluid flow into the mass-reduction slot 200.

As shown in FIG. 7, the blocking lamination 500 may also include one or more openings 506 that are aligned with the openings 314 in the laminations 304, such as to allow one or more assembly structures to pass through the openings 506 into the openings 314. As shown in FIG. 7, the mass-reduction slot 200 formed by the aligned openings 312 in the laminate stack 300 may pass from the first end to the second end of the laminate stack, between the blocking portions 504 of the blocking laminations 500 at the first and second ends. In the examples of FIGS. 6 and 7, a single blocking lamination 500 is shown at each of end of the laminate stack 300. However, it is appreciated that, in one or more implementations, multiple (e.g., two or more) blocking laminations 500 may be stacked at the first end 601 of the laminate stack 300 and/or multiple (e.g., two or more) blocking laminations 500 may be stacked at the second end 603 of the laminate stack 300. In one or more implementations, the blocking portions 504 of the blocking laminations 500 that are in contact with an outermost one of the laminations 304 may seal a corresponding end of a mass-reduction slot 200.

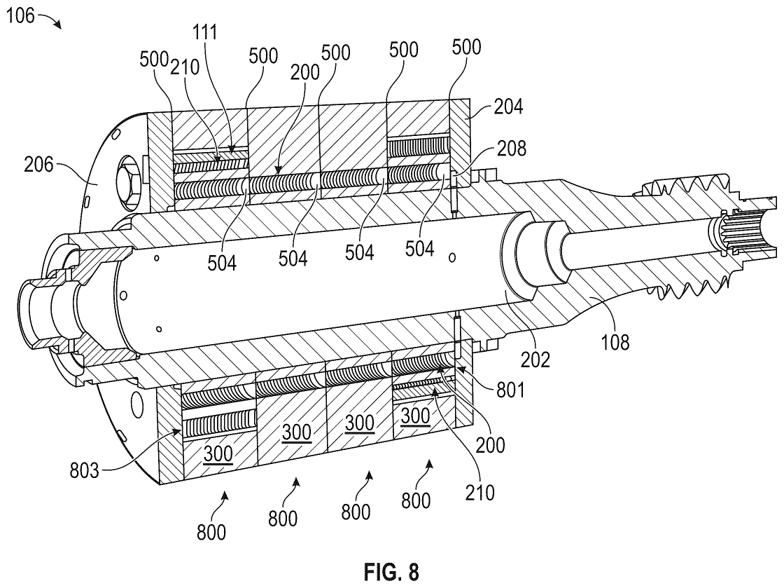

In one or more implementations, a rotor assembly may include multiple layers, each layer formed from a laminate stack 300. In one or more implementations, one or more blocking laminations 500 (e.g., blocking lamination(s) laminated to the first end 601 and/or the second end 603 of each laminate stack) may be disposed between each pair of adjacent layers. For example, FIG. 8 illustrates a cross-sectional perspective view of a rotor assembly 106 having four layers 800. Although four layers 800 are shown in FIG. 8, this is merely illustrative, and fewer than four, or more than four layers may be included in various implementations.

As shown, each layer 800 may include a laminate stack 300, and the layers 800 may be separated from each other by blocking laminations 500 (e.g., one or more blocking laminations 500 at the ends of each laminate stack 300). As shown, a blocking lamination 500 may be located between the first end plate 204 and an outermost laminate stack 300 (e.g., an outermost layer 800) at a first end 801 of the rotor assembly 106, and a blocking lamination 500 may be located between the second end plate 206 and an outermost laminate stack 300 (e.g., an outermost layer 800) at a second end 803 of the rotor assembly 106. As shown, one or more additional blocking laminations 500 may be located between the first end 801 and the second end 803 of the rotor assembly (e.g., between each of the layers 800). In this way, the blocking portions 504 of the blocking laminations 500 may be positioned to block fluid flow (e.g., of a fluid that is flowing through the fluid channels 210) into the mass-reduction slot(s) 200.

In the example of FIG. 8, a single blocking lamination 500 is shown at each end of the laminate stack 300 of each layer 800. However, as discussed herein in connection with FIG. 6, in one or more implementations, two or more blocking laminations 500 may be provided at one or both ends of any of the laminate stacks 300 (e.g., between or at the outer end of any of the layers 800). As shown in FIG. 8, the outermost blocking lamination(s) 500 at (or near) the first end 801 of the rotor assembly may be disposed between the outermost lamination 304 at that end and the first end plate 204. As shown in FIG. 8, the outermost blocking lamination(s) 500 at (or near) the second end 803 of the rotor assembly may be disposed between the outermost lamination 304 at that end and the second end plate 206. For example, the first end plate 204 may be adjacent to one side of a blocking lamination 500, and a lamination 304 may be adjacent to the other side of that blocking lamination 500 in one or more implementations. For example, the second end plate 206 may be adjacent to one side of another blocking lamination 500, and a lamination 304 may be adjacent to the other side of that other blocking lamination 500 in one or more implementations.

In one or more implementations, the layers 800 may be circumferentially aligned with each other, such that the openings 306 in each laminate stack 300 align with corresponding openings 306 in the other laminate stacks 300 in parallel with the central axis 112, such that the openings 312 in each laminate stack 300 align with corresponding openings 312 in the other laminate stacks 300 in parallel with the central axis 112, and the openings 314 in each laminate stack 300 align with corresponding openings 314 in the other laminate stacks 300 in parallel with the central axis 112. In one or more other implementations, each of the layers 800 may be circumferentially offset with respect to an adjacent one of the other layers 800. Such an offset can provide flow in a non-axial path through each of the fluid channels 210. For example, the fluid channels 210 can extend in a linear or non-linear path that winds partially about the central axis of the rotor assembly 106, rather than parallel to the central axis 112. This can result in an inlet passage on one side (e.g., at the first end plate 204) of each of the fluid channels 210 to be circumferentially offset with respect to the outlet passage on the opposite side (e.g., at the second end plate 206) of the corresponding one of the fluid channels 210. As such, the fluid channels 210 can generally form a helical path around the central axis 112 in some implementations. Such a helical path can facilitate travel of the fluid therethrough as the rotor assembly 106 rotates. It will be understood that the fluid channels 210 can extend in other ways, such as parallel to the central axis 112 of the rotor assembly 106 and/or to each other.

In one or more implementations in which the layers 800 are circumferentially offset with respect to an adjacent one of the other layers 800 (e.g., and the fluid channels 210 form a helical path around the central axis 112 in some implementations), the portion of a mass-reduction slots 200 in each layer 800 may also be offset with respect to the portion of that mass-reduction slot 200 in an adjacent layer 800 (e.g., such that the mass-reduction slots 200 also each form a helical or other non-linear path, such as a winding path, around the central axis 112), or, as shown in the example of FIG. 8, the portions of the mass-reduction slots 200 that are within each layer 800 may align with each other (e.g., such that the mass-reduction slots 200 each form a linear path parallel to the central axis 112).

In one or more implementation in which the layers 800 are circumferentially offset with respect to an adjacent one of the other layers 800 (e.g., and the fluid channels 210 form a helical path around the central axis 112 in some implementations), the portions of an assembly hole that are disposed within each layer 800 (e.g., formed by the openings 314 in the laminations 304 of that layer 800) may be aligned with each other (e.g., such that the assembly holes each form a linear path parallel to the central axis 112 through which a bolt or other assembly and/or manufacturing component can extend).

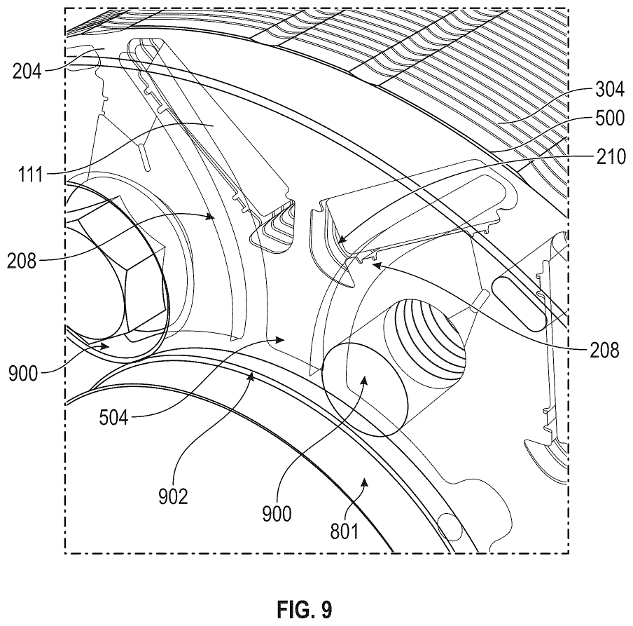

FIG. 9 illustrates a perspective view of a portion of the rotor assembly 106 of FIG. 8, with the first end plate 204 at the first end 801 of the rotor assembly 106 shown in partial transparency, so that first inlet passages 208 to the fluid channels 210 can be seen. In this example, the permanent magnets 111 can also be seen partially filling the fluid channels 210. As shown, the first inlet passages 208 may be formed at least partially within the first end plate 204, and arranged to guide fluid from the shaft channel 202 (see, e.g., FIG. 1 or 8) to the fluid channels 210. As shown, one or more of the first inlet passages 208 may pass at least partially over (or near) the blocking portion 504 of the blocking lamination(s) 500 at the first end 801 of the rotor assembly 106. In this arrangement, the blocking portions 504 prevent fluid that is flowing through the first inlet passages 208 from flowing into the mass-reduction slots 200 (not visible in FIG. 9 due to being blocked by the blocking portions 504). In this arrangement, at least a sub-portion of the blocking portion 504 forms a wall of part of a first inlet passage 208, the other walls of the first inlet passage 208 formed by the channel in the first end plate 204.

As shown in the example of FIG. 9, in one or more implementations, the first end plate 204 can include an annulus 902 for collecting fluid. The annulus 902 can be continuous about a central region (e.g., for receiving the rotor shaft) and can fluidly connect to each of the first inlet passages 208. The first end plate 204 can also include one or more recesses for collecting additional fluid in one or more implementations. The collection of fluid in the annulus 902 (e.g., and/or the recesses) can help direct fluid into the first inlet passages 208, particularly as the rotor assembly rotates about the central axis 112 and the centrifugal forces urge the fluid radially outwardly. In one or more implementations, some or all of the blocking portion 504 may be adjacent the annulus 902 (e.g., and may block fluid within the annulus from entering the mass-reduction slot(s) 200).

The first end plate 204 can further include one, two, or more than two (e.g., eight) first inlet passages 208. For example, a fluid, such as oil, that is directed into the first inlet passages 208 from a shaft channel of a rotor shaft, may then flow from the first inlet passages 208 (e.g., past the blocking portions 504) into longitudinally (e.g., axially or helically) directed fluid channels 210 (e.g., and out of outlet passages of another end plate (e.g., a second end plate 206, which may be identical to the first end plate 204 but clocked 45 degrees azimuthally in some implementations).

The first inlet passages 208 can have a curved shape, such as the curved shape shown in FIG. 9, that helps distribute the fluid while the rotor assembly rotates. For example, the first inlet passages 208 can extend from the annulus 902 in a radially outwardly direction (e.g., orthogonal to the rotor axis of rotation) to facilitate motion of the fluid from the annulus 902.

The curved paths can further extend the flow to and/or across one or more fluid channels 210 and/or portions thereof. In some implementations, the first inlet passages 208 can branch into multiple paths, which can extend (e.g., over one or multiple blocking portions 504) to each of multiple fluid channels 210 and/or across multiple potions of such fluid channels. The first end plate 204 can also include second outlet passages, through which the fluid exits after flowing from a recess of the other end plate through fluid channels of the rotor. In an illustrative example discussed herein, a rotor may include two end plates (e.g., a front plate and a rear plate), each identical to the first end plate 204, and clocked relative to each other, to form a cross-flow pattern. FIG. 9 also shows how the first end plate 204 may include openings 900 that align with the openings 314 in the laminations 304, and may extend over the openings 502 and 306 that form the fluid channels 210.

As illustrated by FIGS. 1-9, in one or more implementations, a rotor assembly 106 may be provided for a motor 100, the rotor assembly including a rotor core 110 formed of multiple layers 800 arranged along a rotor axis (e.g., central axis 112). In one or more implementations, each of the multiple layers 800 include a laminate stack 300 that includes multiple laminations 304 in a stacked configuration (e.g., as shown in FIGS. 3, 6, and 7). The multiple laminations 304 in each laminate stack 300 may include a first set of respective openings 306 that are coaligned to form at least a portion of a fluid channel 210 for a fluid flow through the rotor core. The multiple laminations 304 of each laminate stack 300 may also include a second set of respective openings 312 that are coaligned to form at least a portion of a mass-reduction slot 200 through the rotor core, and that are blocked (e.g., by blocking portions 504) from receiving the fluid flow.

The rotor core 110 may also include a first blocking lamination 500 at or near a first end (e.g., first end 801) of the rotor core, a second blocking lamination 500 at or near a second end (e.g., second end 803) of the rotor core, and one or more additional blocking laminations 500, each additional blocking lamination disposed between two of the multiple layers 800 (e.g., as shown in FIG. 8). In one or more implementations, each of the first blocking lamination 500, the second blocking lamination 500, and the one or more additional blocking laminations 500 may include an opening 502 aligned with the first set of respective openings 306 in the laminate stack 300 of an adjacent one of the multiple layers 800 to allow fluid to flow through the fluid channel 210. In one or more implementations, each of the first blocking lamination 500, the second blocking lamination 500, and the one or more additional blocking laminations 500 may also include a blocking portion 504 that extends over the second set of respective openings 312 in the laminate stack 300 of the adjacent one of the multiple layers 800 to block the fluid flow into the mass-reduction slot 200.

In one or more implementations, the rotor assembly 106 may also include an end plate (e.g., first end plate 204) coupled to the laminate stack 300 of one of the multiple layers 800 at a first end 801 of the rotor core 110, the end plate at least partially defining a fluid inlet (e.g., first inlet passage 208) that is fluidly coupled to the fluid channel 210. In one or more implementations, the multiple layers 800 are arranged along a rotor axis (e.g., central axis 112), each of the multiple layers 800 being circumferentially offset with respect to an adjacent other one of the multiple layers 800, such that the fluid channel 210 and the mass-reduction slot 200 each wind about the rotor axis between opposing axial ends of the rotor core.

As illustrated by FIGS. 1-9, in one or more implementations, a motor 100 is disclosed that includes a stator 102 including stator coils 104 configured to generate a magnetic field (e.g., a rotating magnetic field), and a rotor (e.g., rotor assembly 106). The rotor may include a rotor shaft 108 that includes a shaft channel 202, and a rotor core 110 disposed about the rotor shaft 108. The rotor core 110 may include a laminate stack 300 that includes laminations 304 in a stacked configuration. The laminations 304 in the laminate stack 300 may include a first set of respective openings 306 that are coaligned to form at least a portion of a fluid channel 210 for a fluid flow through the rotor core 110, and a second set of respective openings 312 that are (i) coaligned to form at least a portion of a mass-reduction slot 200 through the rotor core and that are (ii) blocked from receiving the fluid flow. The rotor core 110 may also include a first blocking lamination 500 at a first end (e.g., first end 801) of the rotor core, a second blocking lamination 500 at a second end (e.g., second end 803) of the rotor core, and one or more additional blocking laminations 500 between the first end and the second end. Each of the first blocking lamination, the second blocking lamination, and the one or more additional blocking laminations may include an opening 502 aligned with the first set of respective openings 306 in the laminate stack 300 to allow the fluid flow through the fluid channel 210, and a blocking portion 504 that extends over the second set of respective openings 312 in the laminate stack 300 to block the fluid flow into the mass-reduction slot 200. In one or more implementations, the motor 100 may be disposed in an electric vehicle.

Providing fluid-blocked mass-reduction slots or cavities in a rotor, as described herein in connection with FIGS. 1-9, may provide rotor mass reduction and lower rotor inertia while maintaining and/or improving motor dynamic performance (e.g., acceleration and disconnect engagement), rotor thermal characteristics, dynamic safety, and motor life expectancy. The strategy discussed herein of directly cooling magnets within a rotor may be provided using assembly interfaces of sub-components (e.g., shaft to end ring to rotor sub-stack) that direct cooling oil to heat sources (e.g., magnets and/or upper or primary core loss regions), that prevent and/or reduce leakages, that provide a balanced flow distribution, and that prevent the escape of oil under high dynamic speeds across all temperature range. As discussed herein, multiple unique laminations 304 within a rotor sub-stack in a strategic arrangement allows the rotor stack assembly to be optimized for both fluid transfer, sealing, flow balancing and distribution, and weight reduction. Additionally, reduced mass improves the overall rotor assembly inertia.

In one or more implementations, a symmetrical arrangement of the unique laminations 304 on the stack assembly exterior and interior features may allow for uniform stress distribution, improving torque retention throughout speed range, and may improve motor performance while having dissimilar lamination geometries. Symmetry of the sub-stacks may also allow for the overall stack assembly skew angle to be configurable to various arrangements, such as to reduce NVH order concerns.

The arrangement of the laminations 304 and blocking laminations 500 disclosed herein may reduce or minimize an unbalance impact of providing both mass reduction and fluid cooling in a rotor. For example, the arrangement of the laminations 304 and blocking laminations 500 may block and/or seal fluid from collecting and trapping inside the mass-reduction holes (e.g., as oil that could otherwise be trapped in these features would contribute to an overall dynamic balance stability, reduce bearing life, and cause NVH concerns). The overall rotor mass reduction described herein, combined with design features allowing the active rotor cooling, improves the thermal characteristics by having less temperature gradient and lower thermal mass, which may improve rotor cooling response or faster cool down between high power transient conditions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term includes, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different orders. Some of the steps, operations, or processes may be performed simultaneously. The accompanying method claims, if any, present elements of the various steps, operations, or processes in a sample order, and are not meant to be limited to the specific order or hierarchy presented. These may be performed in serial, linearly, in parallel, or in different order. It should be understood that the described instructions, operations, and systems can generally be integrated together in a single software/hardware product or packaged into multiple software/hardware products.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

1. A laminate stack for a rotor assembly, the laminate stack comprising:
a plurality of laminations in a stacked configuration, wherein the plurality of laminations include:
a first plurality of respective openings that are coaligned to form at least a portion of a fluid channel for a fluid flow through the laminate stack; and
a second plurality of respective openings that are coaligned to form at least a portion of a mass-reduction slot through the laminate stack, and that are blocked from receiving the fluid flow.

2. The laminate stack of claim 1, further comprising a first additional lamination at a first end of the laminate stack, wherein the first additional lamination includes:
a first opening aligned with the first plurality of respective openings in the plurality of laminations to allow fluid to flow through the first opening into the fluid channel; and
a first blocking portion that extends over the second plurality of respective openings at the first end to block the fluid flow into the mass-reduction slot.

3. The laminate stack of claim 2, further comprising a second additional lamination at a second end of the laminate stack, wherein the second additional lamination includes:
a second opening aligned with the first opening and first plurality of respective openings in the plurality of laminations to allow fluid to flow through the second opening from the fluid channel; and
a second blocking portion that extends over the second plurality of respective openings at the second end to block the fluid flow into the mass-reduction slot.

4. The laminate stack of claim 3, wherein the plurality of laminations further comprise a third plurality of respective openings that are coaligned to form an assembly hole through the laminate stack.

5. The laminate stack of claim 4, wherein the first additional lamination includes a third opening aligned with the third plurality of respective openings to allow an assembly structure to pass through the third opening into the third plurality of respective openings.

6. The laminate stack of claim 1, further comprising a magnet disposed within at least one of the first plurality of respective openings.

7. The laminate stack of claim 1, wherein the first plurality of respective openings have a first shape, and wherein the second plurality of respective openings have a second shape different from the first shape.

8. The laminate stack of claim 7, wherein the first shape is configured to accommodate a magnet and a fluid channel, and wherein the second shape is configured to mitigate at least one of stress or strain on the laminate stack during operation of a motor comprising the laminate stack.

9. The laminate stack of claim 7, wherein the plurality of laminations comprise a plurality of annular laminations that define an axis, and wherein the second shape includes a height along a radial direction away from the axis, and a width that is at least one and a half times the height.

10. The laminate stack of claim 9, wherein the second shape comprise a substantially straight radially inner edge and a substantially curved radially outer edge.

11. The laminate stack of claim 1, wherein the plurality of laminations comprise a plurality of annular laminations that define an axis, and wherein the first plurality of respective openings is radially outward of the second plurality of respective openings.

12. The laminate stack of claim 11, wherein a radius extending radially from the axis through one of the second plurality of respective openings to an outer circumference of the laminate stack does not intersect any of the first plurality of respective openings.

13. A rotor assembly for a motor, the rotor assembly comprising:
a rotor core formed of multiple layers arranged along a rotor axis, wherein each of the multiple layers include:
a laminate stack, comprising:
a plurality of laminations in a stacked configuration, wherein the plurality of laminations in each laminate stack include:
a first plurality of respective openings that are coaligned to form at least a portion of a fluid channel for a fluid flow through the rotor core; and
a second plurality of respective openings that are coaligned to form at least a portion of a mass-reduction slot through the rotor core, and that are blocked from receiving the fluid flow.

14. The rotor assembly of claim 13, wherein the rotor core further comprises:
a first blocking lamination at a first end of the rotor core;
a second blocking lamination at a second end of the rotor core; and
one or more additional blocking laminations, each additional blocking lamination disposed between two of the multiple layers.

15. The rotor assembly of claim 14, wherein each of the first blocking lamination, the second blocking lamination, and the one or more additional blocking laminations include:
an opening aligned with the first plurality of respective openings in the laminate stack of an adjacent one of the multiple layers to allow fluid to flow through the fluid channel; and
a blocking portion that extends over the second plurality of respective openings in the laminate stack of the adjacent one of the multiple layers to block the fluid flow into the mass-reduction slot.

16. The rotor assembly of claim 13, further comprising an end plate coupled to the laminate stack of one of the multiple layers at a first end of the rotor core, the end plate at least partially defining a fluid inlet that is fluidly coupled to the fluid channel.

The rotor assembly of claim 13, wherein the multiple layers are arranged along a rotor axis, each of the multiple layers being circumferentially offset with respect to an adjacent other one of the multiple layers such that the fluid channel and the mass-reduction slot each wind about the rotor axis between opposing axial ends of the rotor core.

18. A motor comprising:
a stator comprising stator coils configured to generate a magnetic field; and
a rotor comprising:
a rotor shaft comprising a shaft channel; and
a rotor core disposed about the rotor shaft and comprising:
a laminate stack, comprising:
a plurality of laminations in a stacked configuration, wherein the plurality of laminations in the laminate stack include:
a first plurality of respective openings that are coaligned to form at least a portion of a fluid channel for a fluid flow through the rotor core; and
a second plurality of respective openings that are blocked from receiving the fluid flow and that are coaligned to form at least a portion of a mass-reduction slot through the rotor core.

19. The motor of claim 18, wherein the rotor core further comprises a first blocking lamination at a first end of the rotor core, a second blocking lamination at a second end of the rotor core, and one or more additional blocking laminations between the first end and the second end, wherein each of the first blocking lamination, the second blocking lamination, and the one or more additional blocking laminations include:
an opening aligned with the first plurality of respective openings in the laminate stack to allow the fluid flow through the fluid channel; and
a blocking portion that extends over the second plurality of respective openings in the laminate stack to block the fluid flow into the mass-reduction slot.

20. The motor of claim 18, wherein the motor is disposed in an electric vehicle.
